(19) United States
(12) Patent Application Publication
(10) Pub. No.: US 2004/0208150 A1
(43) Pub. Date: Oct. 21, 2004

(54) Access Point For Indoor/Outdoor 802.11

(76) Inventors: Ju-Nan Chang, Taipei Hsien (TW); Meng-Hua Kao, Taipei Hsien (TW); Bo-Sheng Hung, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,491

(22) Filed: Apr. 15, 2003

(51) Int. Cl. H04Q 7/24

(52) U.S. Cl. 370/338

(57) ABSTRACT

An access point and related method that is applicable for indoor and outdoor 802.11 IEEE Wireless LAN protocol. The access point can transform data from a wireless local area network (WLAN) module into a wireless wide area network (wireless WAN) module and from a wireless wide area network into a wireless local area network. The access point includes a wireless local area network module for transmitting and receiving wireless local area network packets, a wireless wide area network module for transmitting and receiving wireless wide area network packets, and an adaptor. The adapter can transform packets from a wireless local area network into a wireless wide area network and from a wireless wide area network into a wireless local area network.

### BACKGROUND OF INVENTION

1. Field of the Invention

The present invention provides an access point for an indoor/outdoor 802.11 IEEE Wireless LAN protocol, and more particularity an access point capable of transforming received wireless local area network packets into wireless wide area network packets and then transmitting out the wireless wide area network packets, or of transforming the received wireless wide area network packets into wireless local area network packets and then transmitting out the wireless local area network packets.

2. Description of the Prior Art

In the last ten years, the rapid development of communication technologies brought more and more conveniences to people. One of the examples is a Wireless Local Area Network (WLAN) adopted in office buildings filled with computers. A client of a WLAN can transmit WLAN packets through wireless methods to another WLAN client avoiding the inconveniences of complicated wired systems. However, due to restrictions on the communication distances defined by a WLAN, the clients of a WLAN cannot exchange data with non-WLAN clients or with distant WLAN clients about thousand miles away.

Another rapidly developing technology is a wireless Wide Area Network (wireless WAN) comprising GSM, GPRS, CDMA, WCDMA, 3G, and so on. No matter how far the separation distance, clients can exchange data through the communication tools conforming to these communication agreements. However, a wireless WAN regulates the bandwidth for data transmitting and receiving so the amount of data is restricted when wireless WAN clients exchange simultaneously. For the wireless WAN clients, it is impracticable to transmit a huge amount of data simultaneously even if only to the nearby clients.

### SUMMARY OF INVENTION

It is therefore a primary objective of the claimed invention to provide an access point and related methods for indoor/outdoor 802.11 IEEE Wireless LAN protocol to solve the above-mentioned problems.

According to the claimed invention, an access point includes a Wireless Local Area Network (WLAN) module for transmitting and receiving WLAN packets, a wireless Wide Area Network (WAN) module for transmitting and receiving wireless WAN packets, and an adaptor for transforming WLAN packets into wireless WAN packets and transforming wireless WAN packets into WLAN packets. The wireless local area network conforms to the communication module of IEEE 802.11a/b/g, and the wireless wide area module then can be a communication module for GSM/GPRS/CDMA/WCDMA/EDGE/3G.

An adaptor of the access point can transform WLAN packets into wireless WAN packets received from the access point and then dispatch wireless WAN packets to any location outside the WLAN communication scope. In addition, the adaptor can transform wireless WAN packets into WLAN packets received from the access point and then dispatch WLAN packets to any location inside the WLAN communication scope. Therefore, through increasing the amount of wireless WAN modules, the access point of the claimed invention can transmit more data simultaneously.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of an access point to the present invention.

FIG. 2 is a perspective view of the software structure of the adaptor in the access point to the present invention.

### DETAILED DESCRIPTION

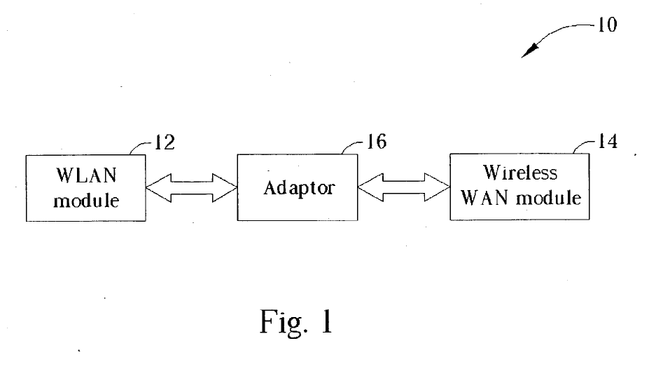

Please refer to FIG. 1. FIG. 1 is a functional block diagram of an access point according to the present invention. The access point 10 comprises a WLAN module 12 conforming to IEEE 802.11a/b/g for transmitting and receiving WLAN packets, a wireless WAN module 14 for transmitting and receiving wireless WAN packets, and an adaptor 16 for transforming WLAN packets into wireless WAN packets and for transforming wireless WAN packets into WLAN packets. The WLAN module 12 can be a WLAN wireless Internet card and the wireless WAN module 14 can be a communication module to provide GSM, GPRS, CDMA, WCDMA, 3G, or EDGE functions. The access point 10 of the present invention can connect to an outside Internet storage device to store a huge amount of data, such as an Internet disk. The access point 10 also can get data from sources such as MP3, FTP, HTTP, and Game servers through Ethernet or ADSL then to store the data on the Internet disk.

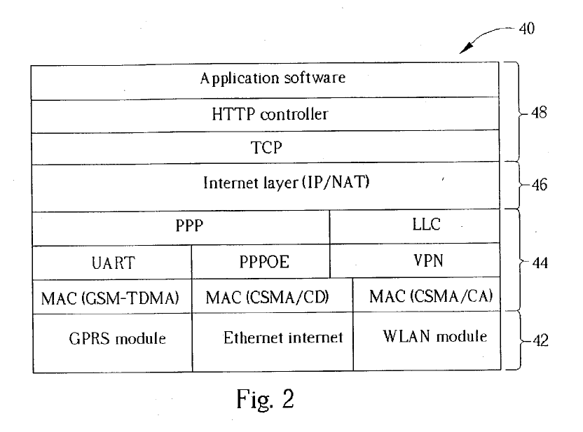

In order to transform effectively the various forms of data transmitting among the different communication agreements, the software structure 40 of the adaptor 16 of the access point 10 of the present invention has a special arrangement. Please refer to FIG. 2. FIG. 2 is a perspective view of the software structure 40 of the access point 10 of the present invention. Similar with a general OSI structure, the software structure 40 also comprises seven layers.

As mentioned above, the access point 10 can connect to an Ethernet to access data in different servers (such as MP3). Therefore, the physical layer 42 of the software structure 40 of the adaptor 16 comprises an Ethernet agreement. Moreover, as the difference of a wireless WAN 14 changes in the access point, the software structure 40 of the adaptor 16 also changes. As an example, if the wireless WAN 14 is a GPRS module, a traffic channel layer 44 of the software structure 40 must comprise a Media Access Control (MAC) related to the GPRS module. Because the access point 10 of the present invention can transform WLAN packets into wireless WAN packets or transform wireless WAN packets into WLAN packets, the physical layer 42 of the software structure 40 needs to comprise the communication agreement applicable to the corresponding WLAN module.

The Internet layer 46 of the software structure 40 comprises two different communication agreements, Internet Protocol (IP) and Network Address Translation (NAT), resulting in the adaptor 16 to have the routing, bandwidth sharing, and firewall functions. So, the adaptor 16 of the access point 10 can mutually connect each client of a WLAN to transmit data, handle the UART/GPRS modules of asynchronous serial data that is converted from IP and NAT of the Internet layer 46 of the software structure 40 through PPP of the traffic layer 44 of the software structure 40, transmit TCP/IP packets to PPP in servers and modems of PPPOE/Ethernet/ADSL belonging to Ethernet, and connect to telecommunication services to store the Internet data.

The top layer 48 of the software structure 40 can construct servers of MP3, FTP, Game, and HTTP in order to increase the application of the adaptor 16. The traffic layer 44 of the software structure 40 comprises a Virtual Private Network (VPN) and a Logical Link Control layer (LLC) that control the flow rate and mistakes of the physical layer 42.

In contrast to the prior art, the present invention access point 10 comprises a wireless WAN module 14 providing the functions of GPRS or 3G, a WLAN module 12, and an adaptor, 16. Thus, the present invention is applicable to indoor (applicable to WLAN) and outdoor (applicable to wireless WAN) functions. Moreover, the present invention access point 10 comprises more wireless WAN modules 14 to increase the bandwidth of wireless WAN of the adaptor 16.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of utilizing an access point to transmit and receive wireless packets comprising:
providing a wireless local area network module to the access point for transmitting and receiving wireless local area network packets;
providing a wireless wide area network module to the access point for transmitting and receiving wireless wide area network packets;
providing an adaptor to the access point for transforming wireless local area network packets into wireless wide area network packets and for transforming wireless wide area network packets into wireless local area network packets;
using the adaptor to transform wireless wide area network packets received from the wireless wide area network module into wireless local area network packets, then transmitting the wireless local area network packets from the wireless wide area network module; and
using the adaptor to transform wireless local area network packets received from the wireless local area network module into wireless wide area network packets, then transmitting the wireless wide area network packets from the wireless wide area network module.

2. The method of claim 1 wherein the adaptor comprises Internet Protocol and Network Address Translation communication agreements.

3. The method of claim 1 wherein the wireless wide area network module is a GSM module.

4. The method of claim 1 wherein the wireless wide area network module is a GPRS module.

5. The method of claim 1 wherein the wireless wide area network module is a CDMA module.

6. The method of claim 1 wherein the wireless wide area network module is a WCDMA module.

7. The method of claim 1 wherein the wireless wide area network module is a 3G module.

8. The method of claim 1 wherein the wireless wide area network module is an EDGE module.

9. The method of claim 1 wherein providing the access point another wireless wide area network module.

10. An access point comprising:
a wireless local area network for transmitting and receiving wireless local area network packets;
a wireless wide area network for transmitting and receiving wireless wide area network packets; and
an adaptor wherein the adaptor is capable of transforming wireless local area network packets received from the wireless local area network into wireless wide area network packets or transforming wireless wide area network packets received from the wireless wide area network into wireless local area network packets.

11. The access point of claim 10 further comprising a wireless wide area network module.
